(19) United States
(12) Patent Application Publication
(10) Pub. No.: US 2010/0024046 A1
(43) Pub. Date: Jan. 28, 2010

(54) METHODS AND SYSTEMS FOR DETECTING A LATERAL INTRUSION OF A SECURE ELECTRONIC COMPONENT ENCLOSURE

(76) Inventors: William S. Johnson, JR., Sunnyvale, CA (US); James S. Arakaki, Campbell, CA (US); Stanley A. Mercado, Santa Clara, CA (US); Michael Steen, San Jose, CA (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/179,284

(22) Filed: Jul. 24, 2008

(51) Int. Cl. G06F 21/06

(52) U.S. Cl. 726/34

(57) ABSTRACT

Methods and systems for detecting lateral intrusion of a secure electronic component enclosure are disclosed. According to one system, the system includes a secure enclosure for enclosing at least one electronic component. The secure enclosure includes a first and a second printed circuit board (PCB) and a security ring sandwiched between the first and second PCBs defining an interior region for enclosing the at least one electronic component. The PCBs define opposite sides of the enclosure and the security ring defines lateral surfaces of the enclosure. The lateral surfaces defined by the security ring are wrapped by at least two wires that define at least two circuits. An intrusion detection module detects an intrusion of the secure enclosure based on a condition of the at least two circuits.

### TECHNICAL FIELD

The subject matter disclosed herein generally relates to tamper detection and protection of electronic component enclosures. More particularly, the subject matter disclosed herein relates to methods and systems for detecting lateral intrusion of a secure electronic component enclosure.

### BACKGROUND

In many electronic or computer applications, it is desirable to protect data or circuitry from unwanted, unlawful, or unauthorized access. Intrusion detection measures have been implemented for detecting such access attempts and for taking steps to protect against the attempts. As different intrusion detection measures become known, intruders are able to devise and implement techniques for circumventing such measures. Accordingly, it is desirable to provide improved or alternative intrusion detection measures for preventing the circumvention of existing measures.

Computer hardware and other electronic circuitry may be protected from tampering by placing the hardware or circuitry in an enclosure. Such a protection measure provides a physical barrier against tamper attempts. An enclosure alone, however, may be vulnerable to physical attacks such as drilling through the enclosure or prying the enclosure open to gain access to hardware or circuitry. Therefore, additional or substitute measures have been developed for preventing intruder access to hardware or circuitry.

One such intrusion detection measure includes an electronic intrusion detection system. Such systems may detect intrusion attempts and, in response to the detection, take action to erase confidential information contained in the enclosure or may take other steps for preventing intruder access. A conventional enclosure may include two printed circuit boards (PCBs) being joined by a security ring so as to create a secure three dimensional volume located inside the security ring and between surfaces of the PCBs. In order to protect against unwanted tampering, each PCB may contain multiple overlapping layers of conductive pathways so that an intruder attempting to gain access to the hardware or circuitry by drilling through the front or back of the PCBs would necessarily disrupt one of the conductive pathways and therefore be detectable as an intrusion. While this may prevent an unwanted access attempt through the PCB surfaces of the enclosure, conventional enclosures may still be vulnerable to side access attempts directed to penetrating the security ring.

One conventional solution for protecting electronic component enclosures from lateral intrusion is to glue flexible circuitry that contains conductive traces embedded in a flexible plastic material, such as Mylar™ around the sides of the device. Therefore, attempts to cut or pierce the flexible circuit surrounding the side of the enclosure in order to gain access to hardware or circuitry will be detectable as an intrusion.

However, problems exist with using a flexible circuit to protect an enclosure from intrusion because such measures may be circumvented by drilling a hole in a space between two traces of the flexible circuit. By drilling through only the Mylar™ material, intrusion detection and prevention hardware may be bypassed and a needle or other device may be inserted in order to gain access to the hardware or circuitry. Another problem with using flexible circuits is that they may be circumvented by applying heat or chemical solvents to dissolve the glue holding the flexible circuit to the seam of the enclosure, which do not damage the conductive traces embedded within the flexible circuit. Because intrusion detection may be based upon a change in the electrical status of the flexible circuitry, removing the flexible circuit in one piece may not be detectable as an intrusion. Thus, it is desirable to provide additional or substitute measures for detecting intrusions and for preventing access to protected hardware or circuitry.

For the reasons set forth above, there exists a need for improved intrusion detection systems for detecting attempts to gain access to a secure electronic component enclosure.

### SUMMARY

Methods and systems for detecting lateral intrusion of a secure electronic component enclosure are disclosed. According to one system, the system includes a secure enclosure for enclosing at least one electronic component. The secure enclosure includes first and a second printed circuit boards (PCBs) and a security ring sandwiched between the first and second PCBs defining an interior region for enclosing the at least one electronic component. The PCBs define opposite sides of the enclosure and the security ring defines lateral surfaces of the enclosure. The lateral surfaces defined by the security ring are wrapped by at least two wires that define at least two circuits. An intrusion detection module detects an intrusion of the secure enclosure based on a condition of the at least two circuits.

According to one method, a secure electronic component enclosure is provided for enclosing at least one electronic component, the secure enclosure including first and second printed circuit boards and a security ring sandwiched between the first and second PCBs defining an interior region for enclosing the at least one electronic component. The PCBs define opposite sides of the enclosure and the security ring defines lateral surfaces of the enclosure. At least two wires are wrapped around the lateral surfaces defined by the security ring and define at least two circuits. An intrusion of the secure enclosure is detected based on a condition of the at least two circuits.

### BRIEF DESCRIPTION OF THE DRAWINGS

Preferred embodiments of the subject matter described herein will now be explained with reference to the accompanying drawings of which:

FIG. 1 is an exploded perspective view of a secure electronic component enclosure including a system for detecting lateral intrusion of the enclosure according to an embodiment of the subject matter described herein;

FIGS. 2A and 2B are a top view and a close-up view diagram of a secure electronic component enclosure including a system for detecting lateral intrusion of the enclosure according to an embodiment of the subject matter described herein;

FIGS. 3A and 3B are a side view and a close-up view diagram of a secure electronic component enclosure including a system for detecting lateral intrusion of the enclosure according to an embodiment of the subject matter described herein;

FIG. 4 is flow chart illustrating exemplary steps for detecting lateral intrusion of a secure electronic component enclosure including a system for detecting lateral intrusion of the enclosure according to an embodiment of the subject matter described herein; and

FIG. 5 is a flow chart illustrating exemplary steps for manufacturing a secure electronic component enclosure including a system for detecting lateral intrusion of the enclosure according to an embodiment of the subject matter described herein.

### DETAILED DESCRIPTION

An intrusion detection system is disclosed that employs conductive components and detection circuits for detecting lateral intrusion of a secure electronic component enclosure. In particular, the intrusion detection systems disclosed herein detect attempts to gain access to protected electronic data, circuitry, computer hardware, or other protected components from unwanted, unlawful, or unauthorized access. A detection module may determine whether a short circuit or an open circuit exists for detecting an intrusion. On detection of an intrusion, the detection module may take action to protect confidential information, such as to generate and transmit a signal indicating the intrusion, which may cause one or more electronic components to be erased.

As used herein, the term “detection module” refers to a circuit for detecting lateral intrusion of a secure electronic component enclosure. A detection module may detect an intrusion by determining that a wire circuit formed by at least two wires wrapped around lateral surfaces of the enclosure is an open circuit or a short circuit. For example, a wire circuit surrounding lateral surfaces of the enclosure may form a complete, uninterrupted, and closed circuit when in a safe state indicating that no tampering has occurred. When there is tampering, the circuit may be broken or shorted such that it is no longer complete and uninterrupted. The detection module may detect this occurrence and be alerted to an intrusion by determining that the circuit has been shorted or interrupted, such as when there is tampering, whether by cutting the wires. Additionally, an intrusion may be detected based on a short circuit when two wires surrounding the secure enclosure touch. For example, the at least two circuits may be shorted when an intrusion attempt is made that includes separating the wires so as to insert a probing needle, or otherwise moving the security wires surrounding the secure enclosure in order to gain access to confidential information. Again, the detection module may detect this occurrence and be alerted to the intrusion.

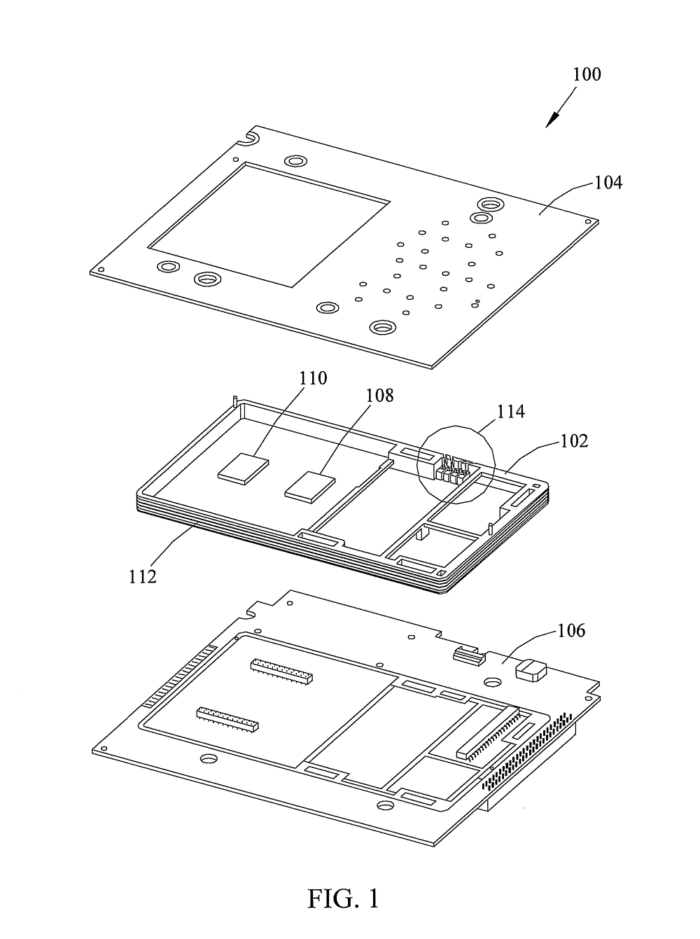

FIG. 1 is a schematic diagram of a secure electronic component enclosure including a system 100 for detecting lateral intrusion of the enclosure according to embodiment of the subject matter disclosed herein. In particular, enclosure 100 may detect attempts to gain access to electronic data, circuitry, computer hardware, or other components contained in enclosure region defined by security ring 102, upper printed circuit board (PCB) 104, and lower PCB 106. Referring to FIG. 1, it is appreciated that PCBs 104 and 106 may be used to mechanically support and electrically connect electronic components using conductive pathways, or traces, etched from copper sheets laminated onto a non-conductive substrate. In one example, enclosure 100 may be a payment card system enclosure for enclosing components of an electronic payment card reader having an integrated PIN entry keypad, such as a magnetic stripe payment card reader, contactless payment card reader, or other NFC payment card reader.

Enclosure 100 may include a secure volume defined by the interior surfaces of security ring 102, PCB 104, and PCB 106. Located within the secure volume may be one or more protected electronic components 108 for storing data to be protected from intrusion, and intrusion detection module 110 for detecting an intrusion of enclosure 100. At least two security wires 112 may be wound laterally around enclosure 100 and may be connected to intrusion detection module 110 for detecting an intrusion of enclosure 100. In the embodiment shown in FIG. 1, a pair of security wires 112 may be wrapped around security ring 102 and connected to contacts 114 for monitoring by intrusion detection module 110.

Security ring 102 may include a plastic form surrounding protected components 108 and intrusion detection module 112. PCBs 104 and 106 may be adhered to the top and bottom surfaces of plastic form 102, respectively, for creating a secure enclosure 100 wherein protected components 108 are protected from top or bottom tampering/intrusion methods. Security ring 102 may include a plastic form for detecting attempts to gain access to protected electronic data, circuitry, computer hardware, or other protected components from unwanted, unlawful, or unauthorized access.

Upper and lower PCBs 104 and 106 may comprise multiple layers of conductive traces and/or pathways embedded in a nonconductive substrate. According to one security measure, in order to prevent unauthorized intrusion of secure enclosure 100 from top or bottom access attempts, PCBs 104 and 106 may be configured such that any attempt to drill through PCBs 104 and 106 will necessarily result in damage to the conductive pathways, which may be detectable as intrusion. For example, PCBs 104 and 106 may contain overlapping conductive pathways such that no gap between pathways for a drill or probing needle can penetrate. Other security measures may also be implemented for protecting enclosure 100 from intrusion from the top and bottom. However, the gap separating PCBs 104 and 106 associated with the circumference of security ring 102 may still be subject to unauthorized intrusion attempts which may not be addressed by the systems described above for preventing top and bottom intrusion attempts.

Protected electronic components 108 may store one or more personal identification number (PIN) keys. For example, when a user operates a PIN PAD device, he or she may swipe his or her credit card so as to initiate a payment transaction. In order to authenticate/authorize the transaction, the user may type in a multi-digit PIN on an attached keypad. These PIN keys may then be encrypted into a so-called PIN block which is only readable by a banking institution having a decryption key. Thus, the PIN PAD device queries the appropriate banking institution as indicated by the information retrieved from the user's payment card for the transaction and the PIN block is decrypted. If authenticated/authorized, the banking institution debits the user's account and transmits a signal to the PIN PAD indicating that the transaction is complete. Thus, if an unauthorized user were to gain access to the PIN information he or she may make unauthorized purchases on a valid user's account. Accordingly, detecting and preventing physical intrusion of a secure enclosure is important to protecting confidential information, such as PIN information, from unauthorized use.

Intrusion detection module 110 may include computer-executable instructions stored in a tangible computer-readable medium that, when executed by a computer, may detect an intrusion of the secure enclosure based on a condition of the first and second wires. For example, intrusion detection module may include a memory and processor configured to detect a short circuit and/or an open circuit condition of the at least two circuits surrounding security ring 102. As a result of determining an intrusion, intrusion detection module 110 may take steps for preventing access to the enclosure or for protecting circuitry or data. In one example, intrusion detection module 110 may generate and transmit a signal indicating the detected intrusion. The signal may be transmitted to another electronic component for taking action to prevent access to the enclosure or for protecting circuitry or data. For example, the signal may cause another component to erase data stored on one or more other electronic components. As a result, an intruder may be prevented from accessing the data.

Security wires 112 may include at least two wires defining at least two circuits. For example, a pair of security wires 112 may be wrapped around the lateral surfaces of secure enclosure 100 and may be connected to intrusion detection module 110. Referring to FIG. 1, security wires 112 may be wrapped around the lateral surfaces defined by security ring 102 and may be connected to contacts 114 for transmitting a signal to intrusion detection module 110 located within enclosure 100. In one embodiment, security wires 112 may include fine gauge insulated wire wrapped around lateral surfaces of security ring 102. Security ring 102 may be a plastic form sized and shaped to enclose protected electronics components and attach to upper PCB 104 and lower PCB 106 to form secure enclosure 100.

Wires 112 may be fine gauge wire, such as 42 American wire gauge (AWG) wire. Each wire may include an insulating coating that is wrapped around the plastic form so as to create a thick layer of wires surrounding the plastic form. The process of wrapping the wires around the plastic form may begin by soldering, or otherwise attaching, one end of each of the wires to contacts on the inside of the plastic form. The plastic form may then be clamped between two flat sheets of material which may act as sidewalls during the winding process. For example, these two flat sheets of material may temporarily take the place of PCBs 104 and 106 that will eventually be attached to security ring 102 in order to make it easier on machinery which performs the winding process. Multiple wires 112 may then be wrapped on the form simultaneously, producing an almost solid mesh of wires comprising several layers.

According to another aspect, alcohol may be applied to the several layers of wires now surrounding the plastic form in order to partially dissolve the insulating coating on wires 112. In this example, the wires may be coated with an alcohol-soluble coating which softens when alcohol is applied. Alcohol may then be applied so as to further intermesh wires 112, wherein after drying any excess alcohol from the process, wires 112 are held together (i.e. their partially dissolved coatings are chemically bonded) by the soluble material.

According to another aspect, a further coating of lacquer, hardening agent, or other protective material may be applied to the wire layers 112 to give security ring 102 additional structural integrity and to prevent any movement of wires 112, whether associated with installation into the final PIN PAD device or with tampering post-installation. After wires 112 are wound on the form, the ends of the two circuits may be soldered to two terminating contacts inside the form.

Upon completing the winding process on security ring 102, security ring 102 may be adhered to PCB 106, and the two security wire circuits may be connected to any necessary electronics. These electronics may include, for example, zebra strips or other connections associated with the protection of the secured area for providing full compliance with PCI standards for PIN PAD security. One way to accomplish connection between a printed circuit board and a display in the form of a liquid crystal display (LCD) is to utilize a conductive rubber device. Such a conductive rubber device is normally referred to as a “zebra strip.” The LCD may be connected to the underlying printed circuit board by arranging the zebra strip between the LCD and the printed circuit board.

Similarly, upper PCB 104 may be adhered to security ring 102 such that security ring 102 is sandwiched between upper PCB 104 and lower PCB 106 comprising secure enclosure 100. Various electronics connections may then be made to PCB 104, and enclosure 100 may be inspected for structural integrity of security wires 112.

An advantage of the subject matter described herein for surrounding a portion of secure enclosure 100 with security wires 112 is that unwanted access attempts based on drilling, piercing, separating, or removing security wires 112 will result in one of a short circuit or an open circuit condition, which are detectable by intrusion detection module 110. Due to the close physical proximity of the at least two security wires 112 associated with wrapping multiple revolutions of fine gauge wire around security ring 102 and partially dissolving their insulating coating and affixing security wires 112 into place with a hardening lacquer finish, any movement of wires 112 may be detectable based on a change in the condition of wires 112.

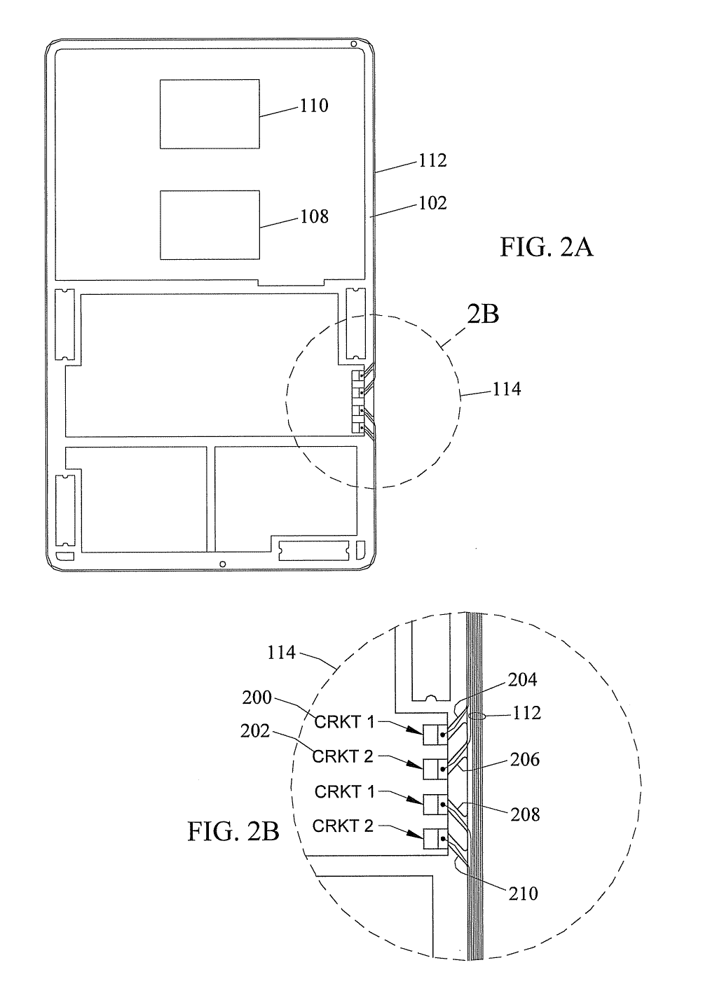

FIGS. 2A and 2B are a front view and a close-up view diagram of a security system for detecting lateral intrusion of a secure enclosure according to an embodiment of the subject matter described herein. Referring to FIG. 2A, security ring 102 may enclose protected hardware and/or circuitry, including but not limited to protected components 108 and intrusion detection module 110. For example, security ring 102 may include a plastic form that may be affixed to upper and lower PCBs 104 and 106 in order to form a three-dimensional protected volume. As described above, upper and lower PCBs 104 and 106 may prevent intrusion of the secure area via a top or bottom intrusion attempt. However, the gap between upper and lower PCBs 104 and 106 corresponding to the space created by security ring 102 may be vulnerable to side intrusion attempts. Accordingly, the subject matter herein includes surrounding security ring 102 with security wires 112 for detecting an intrusion, which is described in greater detail below.

As shown in FIG. 2A, security wires 112 may include two wires wrapped around security ring 102 multiple times in order to produce a solid mesh of wires. Therefore, any movement of either the first or second wires after being wound around security ring 102 and set into a final position would result in contact between the first and second wires, and a short circuit would be created. This condition of security wires 112 may be identified as an unauthorized intrusion attempt and may be communicated to intrusion detection module 110. In response to detecting the intrusion, intrusion detection module 110 may prevent access to confidential information stored in protected components 108. In one embodiment, intrusion detection module 108 may transmit a signal to a memory device storing protected components 112 configured to erase protected components 110 from the memory device.

FIG. 2B illustrates a more detailed view of the circuit connections for the first and second security wires according to an embodiment of the subject matter described herein. Referring to FIG. 2B, one end of a first wire associated with circuit 200 may be attached to contact 204 and, similarly, one of a second wire associated with circuit 202 may be attached to contact 206. For example, the first and second wires 112 may be soldered to contacts 204 and 206 via any suitable method known in the art, including but not limited to the application of heat and electric current to the solder. After soldering one end of each of the first and second wires 112 to starting contacts 204 and 206, the first and second wires may be wrapped multiple times around security ring 102 so as to form a solid mesh of wires. The terminal ends of the first and second wires may then be attached to contacts 208 and 210 respectively in order to complete secure circuits 200 and 202.

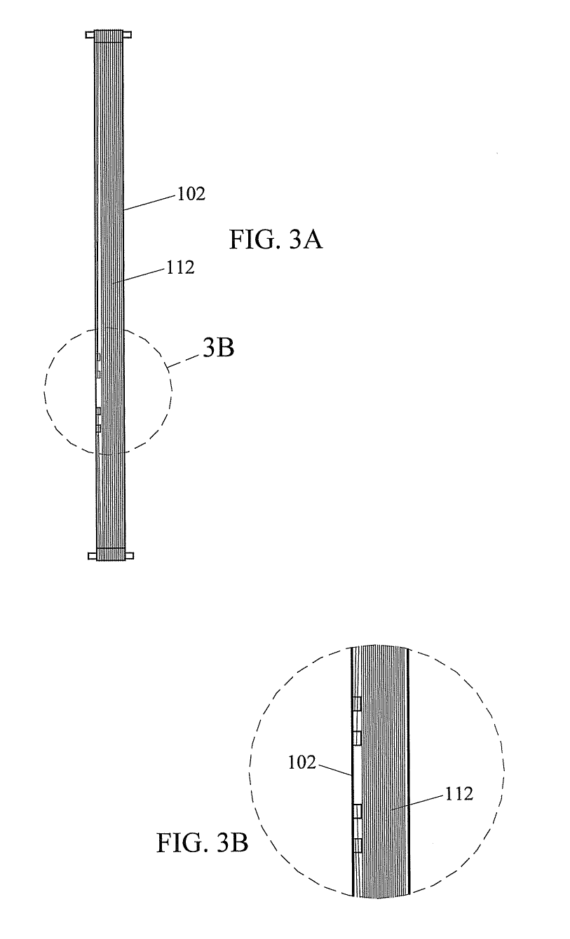

FIGS. 3A and 3B are a side view and a more detailed view of a security system for detecting lateral intrusion of a secure electronic component enclosure according to an embodiment of the subject matter described herein. FIGS. 3A and 3B show at least two wires wrapped around security ring 102 in many overlapping layers so as to form a mesh of wires. For example, at least two wires may be wrapped in parallel around security ring 102 in order to create overlapping layers of wire as described above. In FIG. 3A, security ring 102 may be approximately 6.6 mm wide and may be surrounded by several layers of fine gauge wire associated with a first and second security circuits. Referring to FIG. 3B, a more detailed view illustrating the close physical proximity of the wires to each other is shown. It is appreciated that an intrusion attempt, such as spreading the at least two wires apart in order to form an aperture for insertion of a probe or other device into the secure area of a PIN pad device, will result in contact between the wires. As described above, contact between two or more wires would create a short circuit condition in at least one of security circuits 200 and 202. A short circuit of one of security circuits 200 and 202 may be associated with an intrusion condition indicating that an unauthorized intrusion attempt was made. Based on the detected intrusion condition, intrusion detection module 110 may secure protected components 108, such as by automatically erasing protected components 108 or otherwise rendering it inaccessible to the unauthorized user.

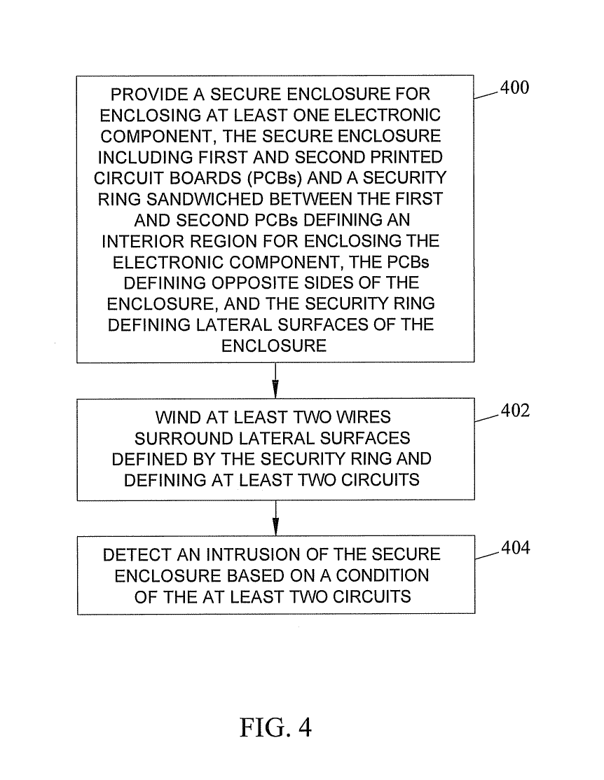

FIG. 4 is a flow chart illustrating a process for detecting and preventing intrusion of a secure enclosure according to an embodiment of the subject matter described herein. Referring to FIG. 4, in block 400, a secure enclosure for enclosing at least one electronic component 108 is provided. For example, secure enclosure 100 may include first and second printed circuit boards (PCB) 104 and 106 and a security ring 102 sandwiched between the first and second PCBs 104 and 106 defining an interior region for enclosing the electronic component 108, the PCBs defining opposite sides of the enclosure, and the security ring 102 defining lateral surfaces of the enclosure 100.

In block 402, lateral surfaces defined by security ring 102 are wrapped by at least two wires 112 that define at least two circuits. For example, at least two security wires 112 may be wrapped around the lateral surfaces of enclosure 100 and may be connected to intrusion detection module 110 for detecting an intrusion of enclosure 100.

In block 404, an intrusion of the secure enclosure is detected based on a condition of the at least two wires 112. For example, an intrusion condition may include one of an open circuit and a short circuit condition produced by security circuits defined by wires 112. In a default “safe state”, the first and second wires may be in close physical proximity, but not in physical contact, such that each security circuit is closed. Therefore, any change in the physical structure of the wires corresponding to an intrusion attempt will result in an interruption of a security circuit or a short circuit. Each of these conditions of wires 112 surrounding security ring 102 may be detected by intrusion detection module 110 and action may be taken to protect electronic components 108. In one embodiment, PIN keys and other confidential information may be erased in response to detecting an intrusion.

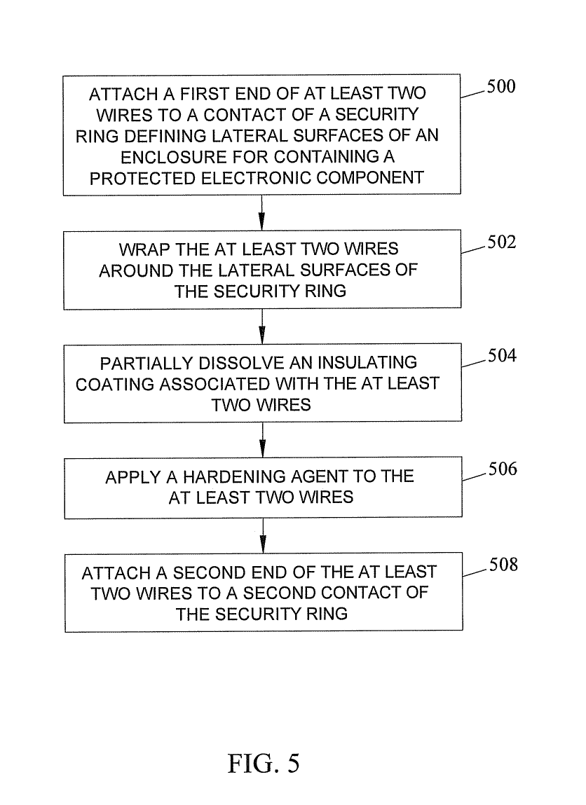

FIG. 5 is a flow chart illustrating exemplary steps for manufacturing a secure electronic component enclosure including a system for detecting lateral intrusion of the enclosure according to an embodiment of the subject matter described herein. Referring to FIG. 5, in block 500, a first end of at least two wires is attached to a contact of a security ring defining lateral surfaces of an enclosure for containing a protected electronic component. For example, one end of a first wire may be attached to contact 204 and, similarly, one end of a second wire associated with circuit 202 may be soldered to contacts 204 and 206, respectively, via any suitable method known in the art, including but not limited to the application of heat to the solder.

In block 502, after soldering one end of each of the first and second wires 112 to starting contacts 204 and 206, the at least two wires are wrapped around the lateral surfaces of the security ring. For example, the first and second wires may be wrapped multiple times around security ring 102 so as to form a solid mesh of wires. Each wire may include an insulating coating that is wrapped around the plastic form so as to create a thick layer of wires surrounding the plastic form. The process of wrapping the wires around the plastic form may include clamping the security ring between two flat sheets of material which may act as sidewalls during the winding process. For example, these two flat sheets of material may temporarily take the place of PCBs 104 and 106 that will eventually be attached to security ring 102 in order to make it easier on machinery which performs the winding process. Wires 112 may then be wrapped on the form simultaneously, producing an almost solid mesh of wires comprising several layers.

In block 504, an insulating coating associated with the at least two wires is partially dissolved. For example, alcohol may be applied to the several layers of wires surrounding the plastic form in order to partially dissolve the insulating coating on wires 112. In one embodiment, wires 112 may be coated with an alcohol-soluble coating which softens when alcohol is applied. Alcohol may then be applied so as to further intermesh wires 112, wherein after drying any excess alcohol from the process, wires 112 are held together (i.e. their partially dissolved coatings are chemically bonded) by the soluble material.

In block 506, a further coating of lacquer, hardening agent, or other protective material may be applied to the wire layers 112 to give security ring 102 additional structural integrity and to prevent any movement of wires 112, such as movement associated with post-installation tampering.

In block 508, the terminal ends of the first and second wires may then be attached to a second contact of the security ring, such as contacts 208 and 210, respectively, in order to complete secure circuits 200 and 202.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A security system for detecting lateral intrusion of a secure enclosure, the security system comprising:
a secure enclosure for enclosing at least one electronic component, the secure enclosure including first and second printed circuit boards (PCBs) and a security ring sandwiched between the first and second PCBs defining an interior region for enclosing the at least one electronic component;
at least two wires being wound around the lateral surfaces defined by the security ring and defining at least two circuits; and
an intrusion detection module coupled to the at least two wires for detecting an intrusion of the secure enclosure based on a condition of the at least two circuits.

2. The security system of claim 1 wherein the intrusion detection module is configured to protect confidential information stored on the electronic component in response to detecting the intrusion.

3. The security system of claim 1 wherein the secure enclosure protects one of a PIN encryption key and a PIN pad key entry stored on the electronic component.

4. The security system of claim 1 wherein the intrusion detection module is configured to detect one of a short circuit and an open circuit condition of the at least two circuits.

5. The security system of claim 1 wherein the at least two wires have a partially dissolved insulating coating.

6. The security system of claim 1 wherein the at least two wires have a lacquer coating.

7. The security system of claim 1 wherein the at least two wires include overlapping windings of wires.

8. The security system of claim 1 wherein the enclosure comprises an electronic payment card reader enclosure having integrated personal identification number (PIN) key entry.

9. The security system of claim 8 wherein the electronic payment card enclosure comprises a magnetic stripe payment card reader enclosure.

10. The security system of claim 8 wherein the electronic payment card enclosure comprises a contactless payment card reader enclosure.

11. The security system of claim 9 wherein the contactless payment card enclosure comprises a near field communications (NFC) payment card reader enclosure.

12. A method for detecting lateral intrusion of a secure enclosure, the method comprising:
providing a secure enclosure for enclosing at least one electronic component, the secure enclosure including first and second printed circuit boards (PCBs) and a security ring sandwiched between the first and second PCBs defining an interior region for enclosing the electronic component, the PCBs defining opposite sides of the enclosure, and the security ring defining lateral surfaces of the enclosure;
winding at least two wires around the lateral surfaces defined by the security ring and defining at least two circuits; and
detecting an intrusion of the secure enclosure based on a condition of the at least two circuits.

13. The method of claim 12 comprising, in response to detecting the intrusion, automatically protecting confidential information stored on the electronic component.

14. The method of claim 13 wherein automatically protecting the confidential information includes erasing the confidential information stored on the electronic component.

15. The method of claim 12 wherein providing a secure enclosure includes providing a secure enclosure for protecting one of a PIN encryption key and a PIN pad key entry stored on the electronic component.

16. The method of claim 12 wherein detecting an intrusion of the secure enclosure includes detecting one of a short circuit and an open circuit condition of the at least two circuits.

17. The method of claim 12 comprising partially dissolving an insulating coating of the at least two wires.

18. The method of claim 12 comprising applying a lacquer coating to the at least two wires.

19. The method of claim 12 wherein winding the at least two wires includes winding multiple overlapping layers of wire around the lateral surfaces defined by the security ring.

20. The method of claim 12 wherein providing a secure enclosure includes providing an electronic payment card reader enclosure having integrated personal identification number (PIN) key entry.

21. The method of claim 20 providing a secure enclosure includes providing a magnetic stripe payment card reader enclosure.

22. The method of claim 20 wherein providing a secure enclosure includes providing a contactless payment card reader enclosure.

23. The method of claim 22 wherein providing a secure enclosure includes providing a near field communications (NFC) payment card reader enclosure.

24. A method for manufacturing a secure enclosure including a system for protecting the enclosure from lateral intrusion, the method comprising:
attaching a first end of at least two wires to a contact of a security ring defining lateral surfaces of an enclosure for containing a protected electronic component;
wrapping the at least two wires around the lateral surfaces of the security ring;
partially dissolving an insulating coating associated with the at least two wires;
applying a hardening agent to the at least two wires; and
attaching a second end of the at least two wires to a second contact of the security ring.
